(19) United States
(12) Patent Application Publication
(10) Pub. No.: US 2006/0077116 A1
(43) Pub. Date: Apr. 13, 2006

(54) Display driving circuit and method and multi-panel display using the same

(75) Inventors: Tzung-Hsien Chen, Huwei Township (TW); Norio Oku, Taipei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/228,824

(22) Filed: Sep. 16, 2005

Related U.S. Application Data
(63) Continuation of application No. 60/617,358, filed on Oct. 8, 2004.

(51) Int. Cl. G09G 5/00

(52) U.S. Cl. 345/1.1

(57) ABSTRACT

The present invention provides a display driving circuit and a display driving method for driving a first panel and a second panel, and provides a multi-panel display using the same. The display driving circuit comprises a data driver for driving a plurality of data lines of the second panel; and a voltage switch circuit, coupling to the data lines for determining whether to conduct a predetermined voltage to the data lines according to ON/OFF status of the first and second panels.

### CROSS-REFERENCE TO RELATED APPLICATION

This application claims the priority benefits of U.S. provisional application filed on Oct. 8, 2004, Ser. No. 60/617,358. All disclosure of this application is incorporated herein by reference.

### BACKGROUND OF THE INVENTION

1. Field of Invention

The present invention relates to a display driving circuit and method. More particularly, the present invention relates to a display driving circuit and method for driving a multi-panel display, and a multi-panel display using the same.

2. Description of Related Art

As the flat panel display, such as LCD or OLED, being widely used in the daily life, a system that provides multi-panel for displaying various information also could be found easily, for example, on mobile phones. On mobile phones, a main panel is set on a first side of the mobile phone with keyboard such that the user may observe whether the mobile phone responds to inputted commands correctly or not. Further, on some mobile phones, an extra sub panel is set on another side of the mobile phone such that information could be displayed thereon to inform the user incoming message or statues of the mobile phone.

A typical circuitry design for driving multi-panel display is shown in FIG. 1, wherein the multi-panel display 10 comprises a controller 12, a first panel 100 and a second panel 150. A main display area 140 is provided on the first panel 100 and a sub display area 180 is provided on the second panel 150. For driving main panel 140, data multiplexer 110 and gate driver 120 are provided on the first panel 100 such that data signals from controller 12 could be sent to data lines in the main display area 140 under control of the data multiplexer 110 and gate driver 120. Besides, for driving sub display area 180, data multiplexer 160 and gate driver 170 are provided on the second panel 150 such that the signals, including data signals provided to the data multiplexer 160 and gate signals for controlling the gate driver 170, could be received from the controller 12 via bus 106, data de-multiplexer 130 and flexible printed circuit (FPC) 14.

The circuitry design stated above provides an approach to drive multi-panel display; however, it brings some problems at the same time. One drawback of the circuitry design is data lines of the sub display area 180 are floating when the sub display area 180 is OFF and the main display area 140 is ON. The floating status of the data lines of the sub display area 180 makes pixel data in the sub display area become abnormal because parasitic capacitance effect in the sub display area 180 or device characteristic difference due to manufacturing process. In other words, parasitic capacitance effect or device characteristic difference causes current leakage such that the pixel data is changed and image displayed on the sub display area 180 could be abnormal when it is OFF.

### SUMMARY OF THE INVENTION

In one aspect, the present invention provides a display driving circuit for driving multi-panel display such that pixel data are kept at a predetermined voltage level when the corresponding panel is turned off and other panel(s) is(are) turned on.

In another aspect, the present invention provides a display driving method for multi-panel display such that data lines of a turned-off panel could be kept at a predetermined voltage level when the data lines are uncoupled from an image source.

In still another aspect, the present invention provides an electronic device and a multi-panel display used therein such that panels of the multi-panel display do not suffer from the drawbacks caused by data line floating.

The present invention provides a display driving circuit for driving a first panel and a second panel. The display driving circuit comprises a data driver for driving a plurality of data lines of the second panel; and a voltage switch circuit, coupling to the data lines for determining whether to conduct a predetermined voltage to the data lines according to ON/OFF status of the first and second panels.

In one embodiment, the display driving circuit further comprises a control bus for transmitting a switch control signal to the voltage switch circuit for determining whether to conduct the predetermined voltage to the data lines; and a controller for providing signals for the data drivers and providing the switch control signal for the control bus. Further, the control bus receives the switch control signal from the controller via a gate driver driving a plurality of gate lines of the second panel. Moreover, the above-mentioned voltage switch circuit comprises a plurality of switches, one end of each of the switches coupling to the predetermined voltage while another end of each of the switches coupling to a corresponding one of the data lines, wherein at least one of the switches being turned on/off according to the switch control signal.

The present invention further provides a display driving method for multi-panel display. The display driving method comprises steps of sending data signals to a plurality of data lines of one of a plurality of panels in the multi-panel display; and providing a predetermined voltage to the data lines when the one of the panels is turned off and at least another one of the panels is turned on.

The present invention also provides a multi-panel display. The multi-panel display comprises a controller providing a plurality of data signals and a switch control signal; a first panel comprising a plurality of first data lines coupling to the controller for receiving the data signals; a second panel comprising a plurality of second data lines coupling to the controller via a interface for receiving the data signals; and a voltage switch circuit, coupling to the second data lines for providing a predetermined voltage to the second data lines according to the switch control signal.

In one embodiment, the interface uncouples the second data lines from the controller when the second panel is turned off, the second panel further comprises a gate driver for driving a plurality of gate lines in the second panel, and the switch control signal is transmitted to the voltage switch circuit from the controller via the gate driver, and, when the first panel is turned on and the second panel is turned off, the controller provides the switch control signal such that the voltage switch circuit provides the predetermined voltage to the second data lines.

The present invention further provides an electronic device. The electronic device comprises an input module, a display device which at least comprises a first panel, a second panel and a voltage switch circuit. The input module provides image data being displayed on the display device to the data lines in the first panel and/or the second panel. The voltage switch circuit couples to data lines of the second panel such that a predetermined voltage can be provided to the data lines of the second panel when the second panel is OFF.

Accordingly, the driving circuit, driving method and multi-panel display in the present invention could keep voltages of the data lines in a turned off panel a constant when other panel is turned on, such that the pixel data could be kept as well.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuitry block diagram of driving circuit for multi-panel display used in the related art.

FIG. 2A is a block diagram of an electronic device according to one embodiment of the present invention.

FIG. 2B is a circuitry block diagram of a multi-panel display and driving circuit therein according to one embodiment of the present invention.

FIG. 3 is a flow chart of a driving method for multi-panel display according to one embodiment of the present invention.

FIG. 4 is a circuitry diagram of a voltage switch circuit according to one embodiment of the present invention.

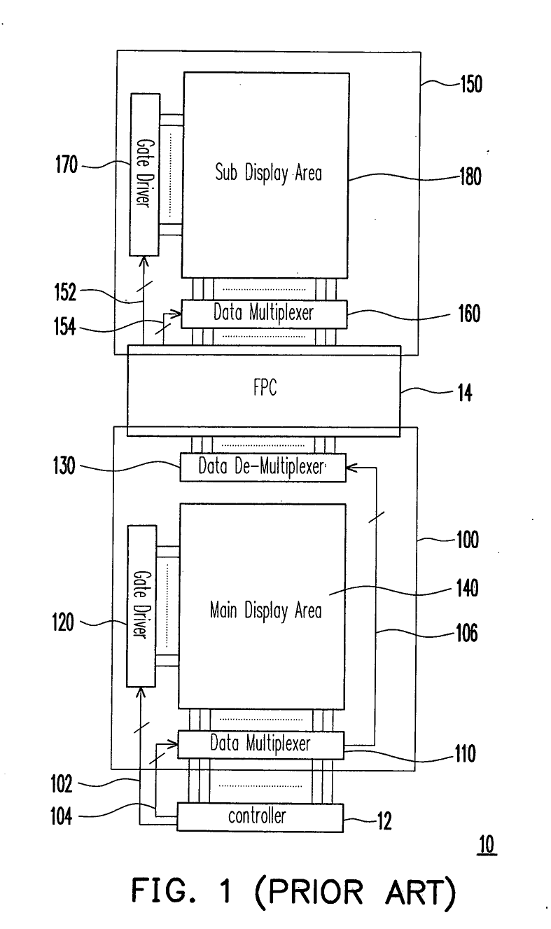

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

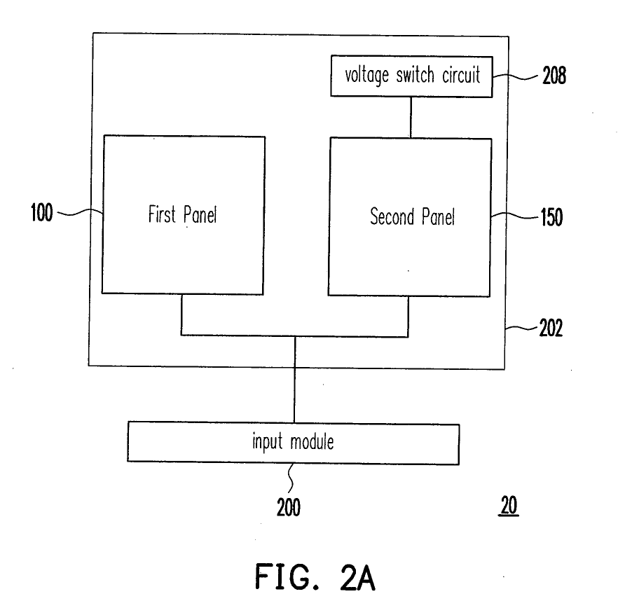

Referring to FIG. 2A, which is a block diagram of an electronic device according to one embodiment of the present invention. The electronic device 20 comprises an input module 200, a display device 202 which at least comprises a first panel 100, a second panel 150 and a voltage switch circuit 208. The input module 200 provides image data being displayed on the display device 202 to the data lines in the first panel 100 and/or the second panel 150. The voltage switch circuit 208 couples to data lines of the second panel 150 such that a predetermined voltage can be provided to the data lines of the second panel 150 when the second panel is OFF, as further explained below. The electronic device 200 may include cellular phone, notebook computer, digital camera or PDA, etc.

For more detailed description of the display device, please refer to FIG. 2B, which is a circuitry block diagram of a multi-panel display and driving circuit therein according to one embodiment of the present invention. The multi-panel display 25 comprises a controller 22, a first panel 100 and a second panel 150. A first display area 204 is provided on the first panel 100 and a second display area 206 is provided on the second panel 150. For driving first display area 204, data driver such as data multiplexer 110 and gate driver 120 are provided on the first panel 100 such that data signals, which are converted by controller 22 from the image data provided from the input module 200, could be sent to data lines 230 in the first display area 204 under control of the data multiplexer 110 and gate driver 120. For driving second display area 206, data multiplexer 160 and gate driver 170 are provided on the second panel 150 such that the signals, including data signals provided to the data multiplexer 160 and gate signals for controlling the gate driver 170, could be received from the controller 22 via bus 106, data de-multiplexer 130 and FPC 14.

Furthermore, a voltage switch circuit 208 is set on the second panel 150 to control provision of a predetermined voltage to the data lines 220. The predetermined voltage could be common-voltage that is used as a reference voltage in the second display area 206 such that a normally white or normally black could be displayed on the second display area 206 when it is turned off. Besides, the predetermined voltage could be other voltages such that the second display area 206 displays other colors when it is turned off.

Moreover, although the controller 22 is a signal source for providing data signals and control signals, such as gate signals for controlling gate driver 120/170 and switch control signal for control voltage switch circuit 208 in the present embodiment, the switch control signal could be generated by other circuits. In other words, as long as the switch control signal could switch the voltage switch circuit 208 in accordance with the on/off switching of the second panel, the switch control signal could be generated by any circuit other than the controller 22.

Further, it should be noted that the data multiplexer 110 and 160 is used as data driver for first display area 204 and second display area 206, respectively; however, this is not a necessary design for those having ordinary skills. In other words, serially or paralleled connected shift registers could be data drivers other than data multiplexer. The data de-multiplexer 130 could be omitted from the circuitry when any circuit other than data multiplexer is used as the data driver.

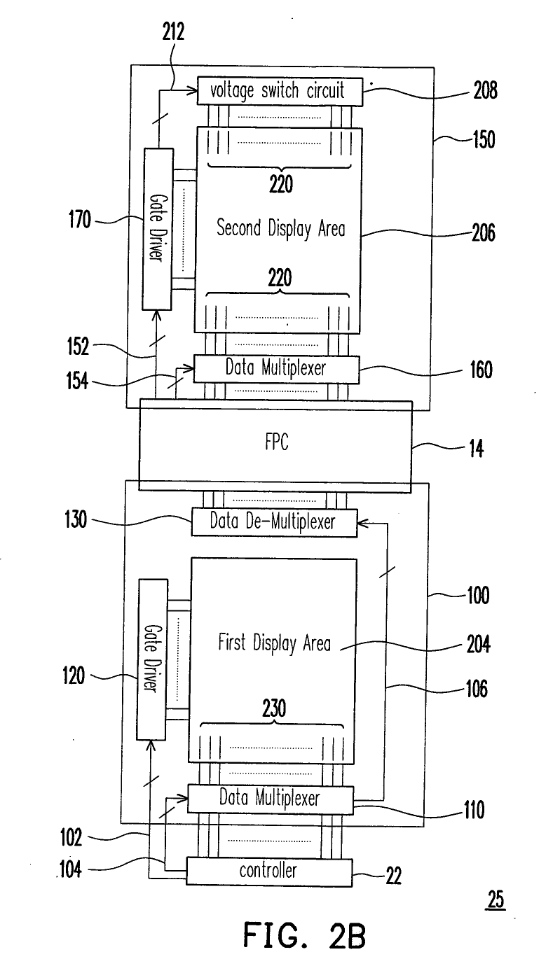

Detailed operations of the embodiment will be described below with referring to both FIG. 2B and FIG. 3, wherein FIG. 3 is a flow chart of a driving method for multi-panel display according to one embodiment of the present invention.

When a panel is turned on, the controller 22 sends out the data signals and gate control signals for controlling the display. For controlling the displaying, a plurality of control signals should be transmitted to the gate driver 170 and/or the data multiplexer 160. For example, color control signals are transmitted to data multiplexer 160 for controlling the data signals to be inputted to red, green or blue pixel, and the gate control signals are transmitted to gate driver 170 for controlling at least one row of pixels are indicated to receive the data signals. These control signals are sent to the data multiplexer (data driver) 160 and gate driver 170 via bus 154 and 152, respectively.

For example, when the second display area 206 is turned on, data lines 220 are coupled to the signal source (here, for second display area 206, the controller 22 is an image source) by enabling conducting paths in data multiplexer 110/160 and data de-multiplexer 130 (Step S300). Thereafter, the controller 22 could send data signals via data multiplexer 110, bus 106, data de-multiplexer 130, FPC 14 and data multiplexer 160 to data lines 220 in the second display area 206 (Step S310).

Once the second display area 206 is going to be turned off and the first display area 204 is kept or going to be turned on, the data lines 220 are uncoupled from the signal source by disable data multiplexer 160 and/or data de-multiplexer 130 for preventing from erroneously displaying images on the second display area 206 (Step S320). However, the operation makes the data lines 220 floating, and, when using the prior art circuitry, current leakage on the data lines 220 will take place.

To overcome the problem, the voltage switch circuit 208 is applied therein. The voltage switch circuit 208 determines whether to conduct a predetermined voltage to the data lines 220 in response to the switch control signal received from bus 212. In other words, switch control signal enables the voltage switch circuit 208 to conduct the predetermined voltage to the data lines 220 when the second display area 206 is in OFF status and the first display area 204 is in ON status (Step S330).

Because the data lines 220 are coupled to the predetermined voltage via voltage switch circuit 208, they are not floated anymore. Therefore, pixel data in the second display area 206 are not suffered from current leakage in the data lines 220.

Although the voltage switch circuit 208 is coupled to the second display area 206 in the embodiment, it can be also coupled to the first display area 204 such that the current leakage in first display area 204 would not occur when the second panel is ON while the first panel is OFF.

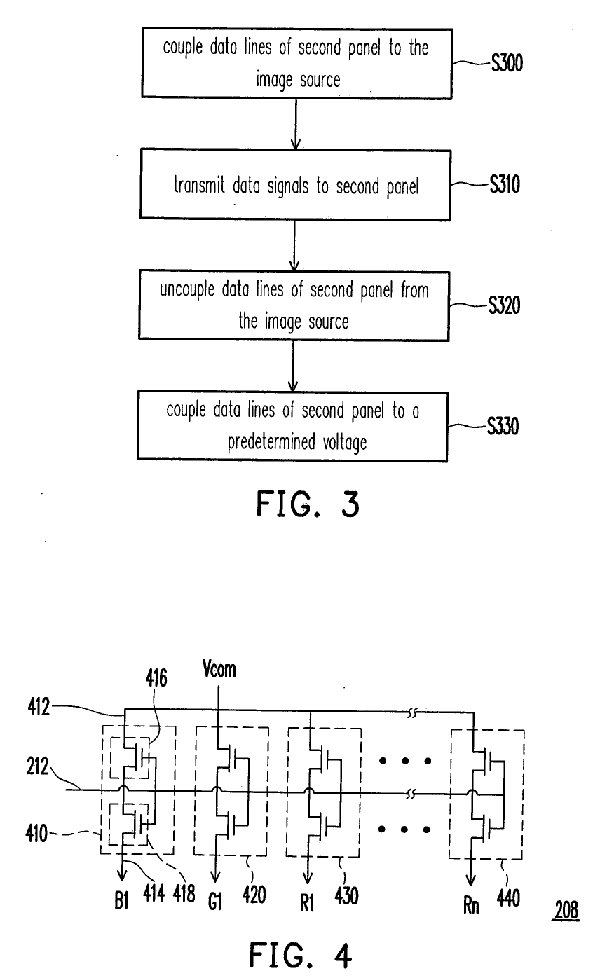

For more detailed description, please refer to FIG. 4, which is a circuitry diagram of a voltage switch circuit according to one embodiment of the present invention. The voltage switch circuit 208 mainly comprises a plurality of switches, such as switches 410, 420, 430 or 440, which are controlled by signals from bus 212 in FIG. 2B to determine whether to couple the data lines R1, G1, B1, R2 and etc. to a common-voltage Vcom. In the embodiment, the switch 410 has one end 412 coupling to the Vcom and another end 414 couples to data line B1 (e.g., one of data lines 220 in FIG. 2B). Vcom could be coupled to one of the data lines when switch control signal on bus 212 enables the corresponding switches 410, 420, 430 or 440 to do so.

Further, in the embodiment, the switch 410 comprising two serially connected MOS's whose gate is coupled to bus 212. A first source/drain of the MOS 416 couples to the common-voltage Vcom, a first source/drain of the MOS 418 couples to a second source/drain of the MOS 416, and a second source/drain of the MOS 418 couples to the corresponding one of the data lines.

Accordingly, a predetermined voltage is coupled to the data lines of one of the panels when the data lines are floating. Therefore, current leakage in the data lines is reduced.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A display driving circuit for driving a first panel and a second panel, comprising:
a data driver for driving a plurality of data lines of the second panel; and
a voltage switch circuit, coupling to the data lines for determining whether to conduct a predetermined voltage to the data lines according to ON/OFF status of the first and second panels.

2. The display driving circuit of claim 1, further comprising:
a control bus, transmitting a switch control signal to the voltage switch circuit for determining whether to conduct the predetermined voltage to the data lines; and
a controller, providing signals for the data driver and providing the switch control signal for the control bus.

3. The display driving circuit of claim 2, wherein the control bus receives the switch control signal from the controller via a gate driver driving a plurality of gate lines of the second panel.

4. The display driving circuit of claim 1, wherein the voltage switch circuit comprises:
a plurality of switches, one end of each of the switches coupling to the predetermined voltage while another end of each of the switches coupling to a corresponding one of the data lines, wherein at least one of the switches being turned on/off according to the switch control signal.

5. The display driving circuit of claim 4, wherein at least one of the switches comprises:
a first MOS comprising a first source/drain, a second source/drain and a gate, the first source/drain of the first MOS coupling to the predetermined voltage and the gate of the first MOS receiving the switch control signal; and
a second MOS comprising a first source/drain, a second source/drain and a gate, the first source/drain of the second MOS coupling to the second source/drain of the first MOS, the second source/drain of the second MOS coupling to the corresponding one of the data lines and the gate of the second MOS receiving the switch control signal.

6. A display driving method for multi-panel display, comprising:
sending data signals to a plurality of data lines of one of a plurality of panels in the multi-panel display; and
providing a predetermined voltage to the data lines when said one of the panels is turned off and at least another one of the panels is turned on.

7. The display driving method of claim 6, wherein the step of sending data signals to the data lines of said one of the panels in the multi-panel display comprises:
coupling the data lines to an image source; and
sending data signals from the image source to the data lines.

8. The display driving method of claim 7, wherein the step of providing the predetermined voltage to the data lines when said one of the panels is turned off and at least another one of the panels is turned on comprises:
uncoupling the data lines of said one of the panels from the image source when said one of the panels is turned off; and
providing the predetermined voltage to the data lines.

9. A multi-panel display, comprising:
a controller providing a plurality of data signals;
a first panel comprising a plurality of first data lines coupling to the controller for receiving the data signals;
a second panel comprising a plurality of second data lines coupling to the controller for receiving the data signals; and
a voltage switch circuit, coupling to the second data lines for providing a predetermined voltage to the second data lines according to a switch control signal.

10. The multi-panel display as claim 9, further comprises an interface, the interface uncouples the second data lines from the controller when the second panel is turned off.

11. The multi-panel display as claim 9, wherein the second panel further comprises a gate driver for driving a plurality of gate lines in the second panel, and the switch control signal is generated by the controller and transmitted to the voltage switch circuit via the gate driver.

12. The multi-panel display as claim 9, wherein when the first panel is turned on and the second panel is turned off, the switch control signal enables the voltage switch circuit to provide the predetermined voltage to the second data lines.

13. The multi-panel display as claim 9, wherein the first panel is main panel and the second panel is sub panel.

14. The multi-panel display as claim 9, wherein the first panel is sub panel and the second panel is main panel.

15. An electronic device, comprising:
a multi-panel display as claim in 9; and
an input module for providing image data to the display device.
